(19) United States
(12) Patent Application Publication
(10) Pub. No.: US 2003/0167414 A1
(43) Pub. Date: Sep. 4, 2003

(54) Systems and methods for power load management

(76) Inventors: Joseph Edward Sutherland, Raleigh, NC (US); Gus Clint Sanders JR., Raleigh, NC (US); Paul Daniel Queen JR., Raleigh, NC (US)

Correspondence Address: ALCATEL USA, INTELLECTUAL PROPERTY DEPARTMENT, 3400 W. PLANO PARKWAY, MS LEGL2, PLANO, TX, 75075, US

(21) Appl. No.: 10/386,237

(22) Filed: Mar. 11, 2003

Related U.S. Application Data
(63) Continuation of application No. 09/459,883, filed on Dec. 14, 1999.

(51) Int. Cl. G06F 1/26

(52) U.S. Cl. 713/300

(57) ABSTRACT

Disclosed is a system and method for providing power load management in a communication system while limiting cost and space requirements.

### BACKGROUND OF THE INVENTION

This Application claims the benefit of application Ser. No. 60/147,140 of JOSEPH EDWARD SUTHERLAND, GUS CLINT SANDERS, JR., AND PAUL DANIEL QUEEN. JR. filed Aug. 4, 1999 for POWER INTERRUPTER FOR LOAD-SHEDDING, the contents of which are herein incorporated by reference.

1. Field of the Invention

This invention relates generally to power load management and, more particularly, to systems and methods of management of loads to conserve power.

1. Description of Related Art

Typical design constraints on electronic systems, such as those for communication services, include limited cost and limited space requirements.

### SUMMARY OF THE INVENTION

It is an object of the present invention to provide systems and methods for power load management without requiring excessive hardware and space.

To achieve this and other objects of the present invention, in a first system including a building with a subscriber, and a structure located away from the building, a communication system comprises a first circuit for sending a first signal from the structure to the building; a second circuit for sending a second signal from the structure to the building, while the first circuit sends the first signal; a generator that generates a DC power signal in response to an AC power signal; a battery coupled to the generator and to the first circuit; a detector that detects a condition of the AC power signal, to generate a detector signal; a switch between the battery and the second circuit, the switch being responsive to the detector signal, to decouple the battery from the second circuit while maintaining a coupling of the battery to the first circuit.

According to another aspect of the present invention there is a communication system for a first system with a building with a subscriber, a structure located away from the building, and a battery. The communication system comprises first sending means for sending a first signal from the structure to the building; second sending means for sending a second signal from the structure to the building, concurrently with the previous means; a conducting path for making a coupling between the battery and the first sending means; means for generating a DC power signal in response to an AC power signal and sending the DC power signal to the battery; means for detecting a condition of the AC power signal, to generate a third signal; and means for selectively decoupling the battery from the second sending means, depending on the third signal, while maintaining the coupling of the battery to the first sending means.

According to yet another aspect of the present invention there is a method for a system including a building with a subscriber, and a structure located away from the building, and a structure enclosing first and second circuits, a battery coupled to the first circuit. The method comprises sending a first signal from the first circuit to the building; concurrently with the previous step, sending a second signal from the second circuit to the building; generating a DC power signal in response to an AC power signal and sending the DC power signal to the battery; detecting a condition of the AC power signal, to generate a third signal; and selectively decoupling the battery from the second circuit, depending on the third signal, while maintaining the coupling, of the battery to the first circuit.

According to yet another aspect of the present invention there is a system for operating with a power line, a power node downstream from the power line, an electrical outlet with a housing having an insulating face plate, the face plate having spaced openings, and electrical contacts in alignment with each of the openings in the face plate, the electrical contacts being coupled to the power line. The system comprises a load for dissipating power from the power node; a power distribution path from the power node to the load, the power distribution path including a switch having a control input, the power distribution path excluding the electrical outlet; and a sensor for monitoring a first signal from the electrical outlet, to send a control signal to the control input of the switch.

According to yet another aspect of the present invention there is a method for system including a power line, a load, and an electrical outlet with a housing having an insulating face plate, the face plate having spaced openings, an electrical contacts in alignment with each of the openings in the face plate, the electrical contacts being coupled to the power line. The method comprises receiving power from the power line through a path including a switch having a control input, and excluding the electrical outlet and dissipating the received power in the load; monitoring a first signal from the electrical outlet, to send a control signal to the control input of the switch.

### BRIEF DESCRIPTION OF THE DRAWINGS

FIG. 1 is diagram of a communication system in accordance with a preferred embodiment of the present invention.

FIG. 2 is a view of an outdoor cabinet in the preferred communication system.

FIG. 3 is a view of a shelf in the cabinet shown in FIG. 2.

FIG. 4 is a diagram of a card in the shelf shown in FIG. 3.

FIG. 5 is a block diagram showing some circuitry in cabinet shown in FIG. 2.

FIG. 6 is a block diagram emphasizing some of the circuitry shown in FIG. 5.

FIG. 7 is a state diagram for describing a process performed by the circuitry shown in FIG. 6.

FIG. 8 is a diagram emphasizing a cabling arrangement in the preferred system.

FIG. 9 is a diagram showing the cabling arrangement of FIG. 8 in more detail.

FIG. 10 shows an electrical outlet of FIG. 8 in more detail.

The accompanying drawings which are incorporated in and which constitute a part of this specification, illustrate embodiments of the invention and, together with the description, explain the principles of the invention, and additional advantages thereof. Throughout the drawings, corresponding parts are labeled with corresponding reference numbers.

### DESCRIPTION OF THE PREFERRED EMBODIMENTS

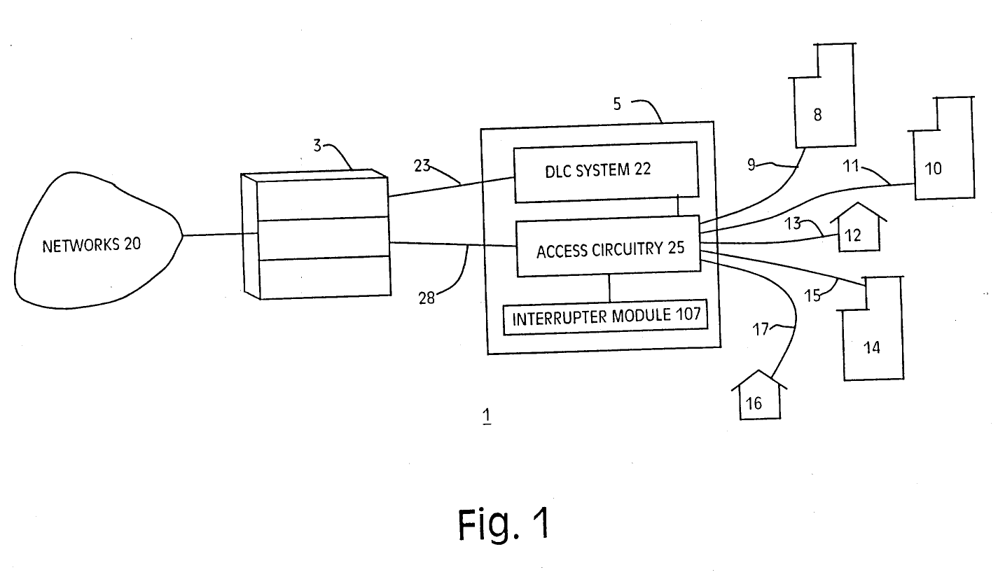

FIG. 1 shows system 1 in accordance with a preferred embodiment of the present invention. System 1 includes central office 3 managed by a telephone company or other type of communication provider. Central office 3 provides communication services to a plurality of subscribers, in office building 8, 10, and 14; and homes 12 and 16. Central office 3 provides communication services to the subscribers via telephone service link 23, data service link 28, remote site 5, and respective subscriber lines 9, 11, 13, 15, and 17. Each subscriber line is a tip and ring twisted pair, including 2 copper wires constituting 2 contiguous current paths between remote site 5 and the building of a subscriber.

Central office 3 includes circuitry that passes data between DS1 link 28 and service provider networks 20 in the global Internet. Thus, system 1 transfers various services between multiple servers and multiple subscribers.

Remote site 5 includes digital loop carrier system 22 and access circuitry 25. In this patent application, the word circuit or circuitry encompass both dedicated analog or digital hardware and programmable hardware, such as a CPU or reconfigurable logic array, in combination with programming data, such as sequentially fetched CPU instructions or programming data for a reconfigurable array.

Interrupter module 107 selectively supplies power to circuitry 25, as described in more detail below.

Access circuitry 25 acts to combine data from networks 20 with an analog, voice band, signal from digital loop carrier system 22, to send a composite signal to subscribers via the subscriber lines. Circuitry 25 receives and encodes data from networks 20 to generate a discreet multitone technology (DMT) signal, combines the DMT signal with an analog signal from digital loop carrier system 22, and sends the composite signal over line 11 to a subscriber in office building 10. Conversely, circuitry 25 receives a composite signal from the subscriber in building 10 via line 11, filters the composite signal to send a digital signal to networks 20, and filters the composite signal to send an analog signal to digital loop carrier system 22.

The exemplary system 1 is optimized for SONET (Synchronous Optical NETwork) OC3 technologies and standards between networks 20 and central office 3, and for DS1 (Digital Signal 1) technologies and standards between central office 3 and remote site 5. Those skilled in the art will understand that the basic architecture of system 1 is applicable to many other technologies and standards.

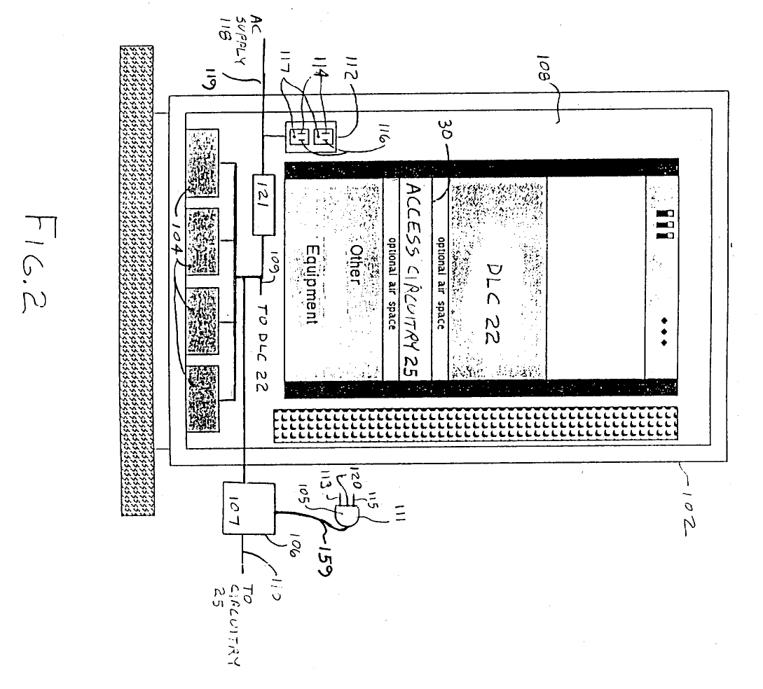

FIG. 2 shows cabinet 102 located at remote site 5. Cabinet 102 encloses DLC system 22, access circuitry 25, and batteries 104. Cabinet 102 receives AC power from 60 Hz AC power source 118, via power line 119. Cabinet 102 includes a door (not shown).

Batteries 104 supply power during disruptions of AC power source 118. More specifically, DLC system 22 is powered by a −48V bank of batteries 104 kept on continuous float-charge by chargers 121 powered by AC source 118, which is the local AC power line. Batteries 104 are sized to run DLC system 22 for a specified time (e.g. 8 hours) during AC power outages in order to maintain lifeline POTS (plain old telephone service), and allow the operating company time to deploy an emergency generator if necessary. Each charger 121 is essentially and AC to DC converter that receives an AC signal from the power line 119 and sends a DC signal toward access circuitry 25.

AC power outlet 112 is on interior wall 108 of cabinet 102. AC power outlet 112 is UL Approved, meaning that AC power outlet 112 conforms to a standard of Underwriters Laboratories Inc. (UL). AC outlet 112 is for powering craft equipment. AC outlet 112 includes 2 sockets each having a left contact 14, a right contact 116, and a ground contact 117. Each of contacts 114, 116, and 117 is in an aperture defined by AC power outlet 112.

Node 109 is common to the output of charger 121 and the outputs of batteries 104. As represented in FIG. 2, the power input of DLC system 22 is connected to node 109.

The power input of interrupter module 107 is connected to node 109. The output of interrupter module 107 is connected to the power input of access circuitry 25. Module 107 is removably connectable to AC outlet 112 via plug 111. Plug 111 includes a body 105 composed of an insulating material, and a left conducting prong 113 for contacting left contact 114, a right prong 115 for connecting with right contact 116, and a ground prong 120 for contacting ground contact 117. Interrupter module 107 selectively supplies power to circuitry 25, depending on the signal from AC source 118, as sensed through plug 111.

More specifically, detector 123 is coupled to left prong 113 and to right prong 115. Detector 123 detects a voltage difference between contacts 114 and contacts 116 (detects a voltage across contacts 114 and contacts 116), by detecting a voltage difference between left prong 113 and right prong 115. In other words, detector 123 monitors AC power line 119 by receiving a signal through contact 114. Detector 123 detects a voltage difference between contact 114 and another node. In the preferred embodiment, the other node is contact 116.

One or more shelves 30, housing access circuitry 25, coexist in cabinet 102 with one or more digital loop carrier systems (DLCs) 22, providing lifeline POTS service. DLC 22 is a digital transmission system for subscriber loop plant. DLC 22 multiplexes many subscriber voice channels onto very few wires or onto a single fiber pair. More specifically, digital loop carrier system 22 may concentrate individual voice lines to T1 lines, cellular antenna sites, PBXs.

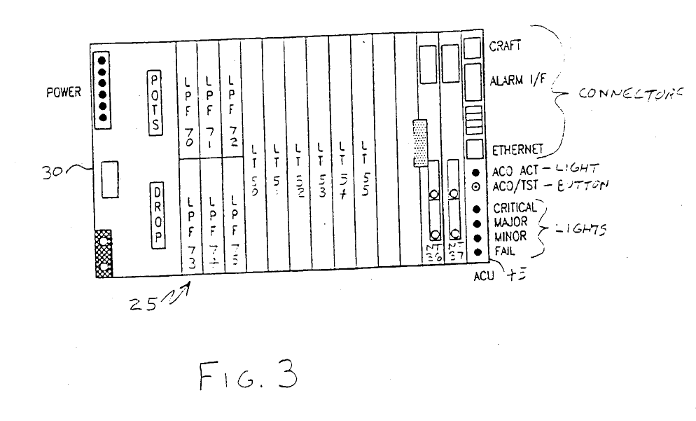

FIG. 3 shows compact shelf 30 supporting access circuitry 25 in remote site 5. Shelf 30 houses low pass filter cards (LPFCs) 70-75, and line termination cards 50-55 (LTs) for communication with subscribers.

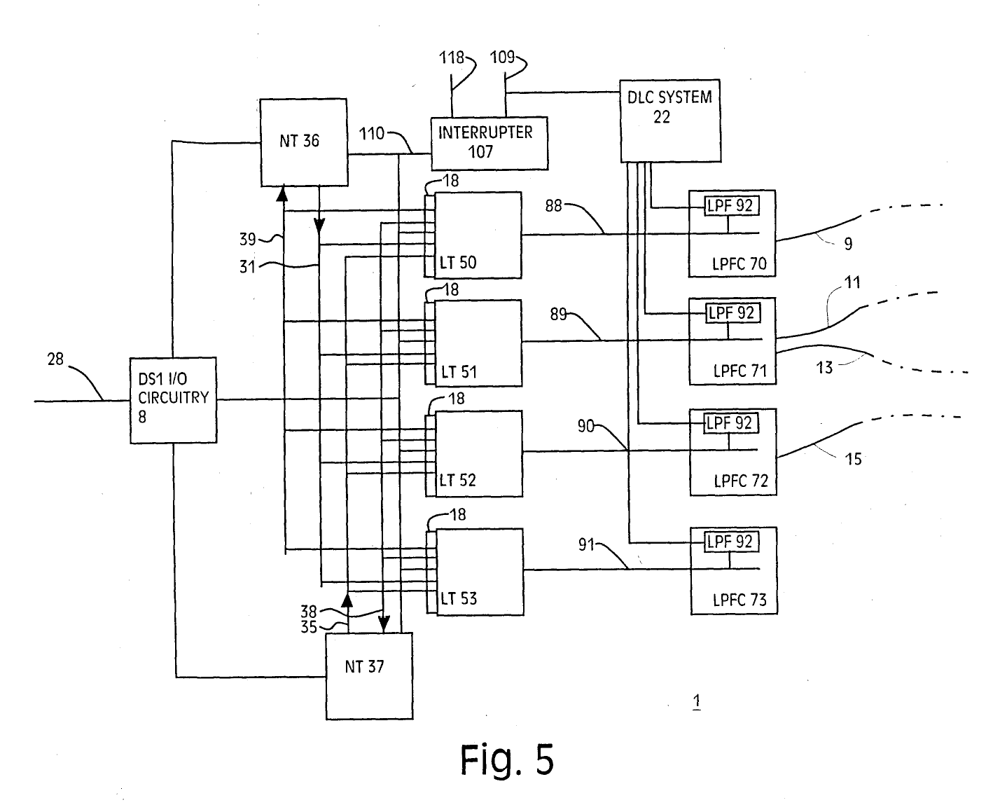

Referring to FIGS. 3 and 5, network termination cards 36 and 37 (NTs) interface with DS1 I/O circuitry 8 leading to DS1 line 28. Alarm-craft interface card 45 collects alarm information from circuitry 25, displays the alarm information locally, and sends the alarm information to other systems. Shelf 30 can accommodate either 1 or 2 NTs, depending on whether redundancy is required. Each LT includes 4 subscriber lines.

Shelf 30 is essentially a mechanical backplane mechanically supporting signal busses 35, 31, 38, and 39. Each of busses 35, 31, 38, and 39 includes a plurality of parallel data lines and a plurality of control lines.

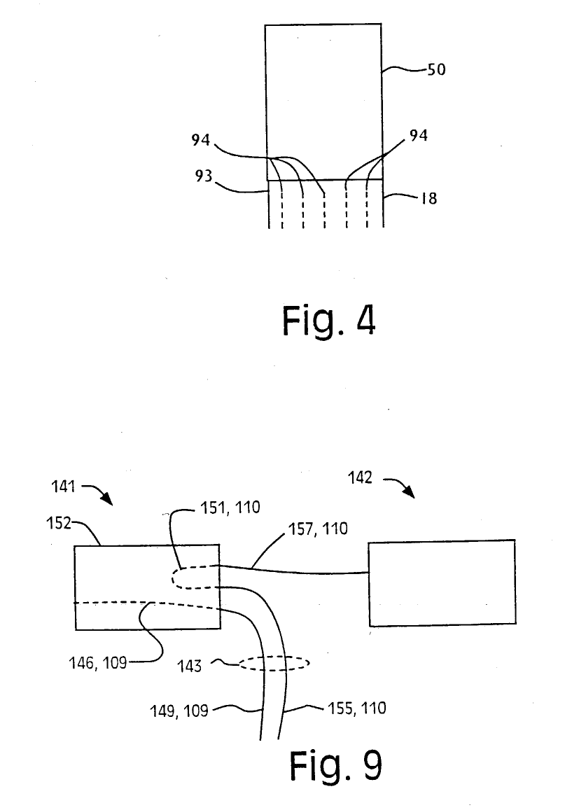

Each of cards 36, 37, 45, 50-55, and 70-75 connects to the mechanical backplane via a respective backplane connector 18, such as connector 18 of card 50 shown in FIG. 4. Each backplane connector 18 includes a plastic, insulating housing 93 enclosing and supporting a plurality of parallel conductors 94 for sending signals between a card and the backplane. For each of cards 36, 37, and 50-55, the conductors are for receiving power from node 110, which is the output of interrupter module 107. For each of cards 36, 37, and 50-55, the conductors are also for sending signals between the card and busses 35, 31, 38, and 39. For example, the conductors inside connector 18 of NT card 37 allow card 37 to sends signals to downstream bus 35 and receive signals from upstream bus 38. The conductors in connector 18 of LT card 51 allow LT card 51 to receive signals from bus 35 and bus 31, and to send signals to bus 38 and bus 39.

Each of cards 36, 37, 45, 50-55, and 70-75 is removably connected to the mechanical backplane.

More details about shelves, such as compact shelf 30, are disclosed in connection with a “RAM (Remote ADSL Mux)” in U.S. patent application Ser. No. 08/891,145 by RICHARD M. CZERWIEC, JOSEPH E. SUTHERLAND, PETER M. L. SCHEPERS, GEERT A. E. VAN WONTERGHEM, MARLIN V. SIMMERING, EDUARD C. M. BOEYKENS, CHRIS VAN DER AUWERA, PETER A. R. VAN ROMPU, KURT PYNAERT, DANIEL A. C. VERLY, GILBERT A. F. VAN CAMPENHOUT, RICHARD H. BAILEY, ROBERT N. L. PESCHI, DIRK M. J. VAN AKEN, EMMANUEL F. BOROWSKI, PETER P. F. REUSENS, HERMAN L. R. VERBUEKEN, FRANK RYCKEBUSCH, KOEN A. G. DE WULF filed Jul. 10, 1997 for TELECOMMUNICATIONS SYSTEM FOR PROVIDING BOTH NARROWBAND AND BROADBAND SERVICES TO SUBSCRIBERS; SUBSCRIBER EQUIPMENT; A SHELF THEREFOR; A REPLACEABLE LOWPASS FILTER UNIT; LINE TERMINATION EQUIPMENT; NETWORK TERMINATION EQUIPMENT; AND A TELECOMMUNICATIONS RACK WITH A PLURALITY, the contents of which is herein incorporated by reference.

The RAM cited in the previous paragraph, is also described in European Patent Application No. 98401239.3 by RICHARD M. CZERWIEC, JOSEPH E. SUTHERLAND, PETER M. L. SCHEPERS, GEERT A. E. VAN WONTERGHEM, MARLIN V. SIMMERING, EDUARD C. M. BOEYKENS, CHRIS VAN DER AUWERA, PETER A. R. VAN ROMPU, KURT PYNAERT, DANIEL A. C. VERLY, GILBERT A. F. VAN CAMPENHOUT, RICHARD H. BAILEY, ROBERT N. L. PESCHI, DIRK M. J. VAN AKEN, EMMANUEL F. BOROWSKI, PETER P. F. REUSENS, HERMAN L. R. VERBUEKEN, FRANK RYCKEBUSCH, KOEN A. G. DE WULF, filed May 25, 1998 for a TELECOMMUNICATIONS SYSTEM FOR PROVIDING BOTH NARROWBAND AND BROADBAND SERVICES TO SUBSCRIBERS; SUBSCRIBER EQUIPMENT; A SHELF THEREFOR; A REPLACEABLE LOWPASS FILTER UNIT; LINE TERMINATION EQUIPMENT; NETWORK TERMINATION EQUIPMENT; AND A TELECOMMUNICATIONS RACK WITH A PLURALITY. The contents of European Patent Application No. 98401239.3 are herein incorporated by reference.

FIG. 5 is a block diagram emphasizing some signal paths in the preferred system. In the example immediately following, NT 37 includes a DS1 port in an active mode and NT 36 includes a DS1 port in a standby mode. Referring FIGS. 3 and 5, each LT has an associated LPF card (LPFC). For example, bus 88 includes 4 pairs of conductors, a pair for each subscriber, between LT 50 and LPFC 70. Bus 89 includes 4 pairs of conductors between LT 51 and LPFC 71. Bus 90 includes 4 pairs of conductors between LT 52 and LPFC 72. Bus 91 includes 4 pairs of conductors between LT 53 and LPFC 73.

An LPFC includes any filtering circuitry provided to the subscriber lines. For example each LPFC includes a respective low pass filters (LPFs) 92 between the subscriber lines and DLC 22.

NT 37 receives Asynchronous Transfer Mode (ATM) cells from DS1 line 28, via circuitry 8, and sends the cells over downstream bus 35. Each ATM cell includes a pair of identifiers: a Virtual Path Identifier (VPI) and a Virtual Channel Identifier (VCI). Each LT recognizes a set of VPI/VCI pairs (addresses) as identifying a cell destined for one or more subscribers connected to the LT. For example, LT 52 recognizes a set of 1 or more VPI/VCI addresses as identifying a cell destined for a subscriber in building 14. Upon recognizing such a cell, LT 52 generates a DMT signal encoding the cell, and sends the signal to LPFC 72. LPFC 72 combines the DMT signal with an analog signal from DLC 22, to send a composite signal to the subscriber in building 14, via line 15.

When a subscriber wishes to send data to service provider networks 20, the subscriber modem encodes the data in a DMT signal and sends the DMT signal over, a subscriber line. This DMT signal passes from one of the LPFCs, to a high pass filter in an LT car, to send a digital signal to NT 37 via upstream bus 38.

Thus, NT card 37, downstream bus 35, and upstream bus 38 act to provide the subscribers with access to service provider networks 20. During this time, NT card 36, downstream bus 31, and upstream bus 39 are in a standby mode in case NT 37, bus 35, or bus 38 should malfunction.

Interrupter module 107 receives DC power on node 109 and selectively passes the DC power to-access circuitry 25 via power node 110, depending on a detected condition of a signal on power line 119.

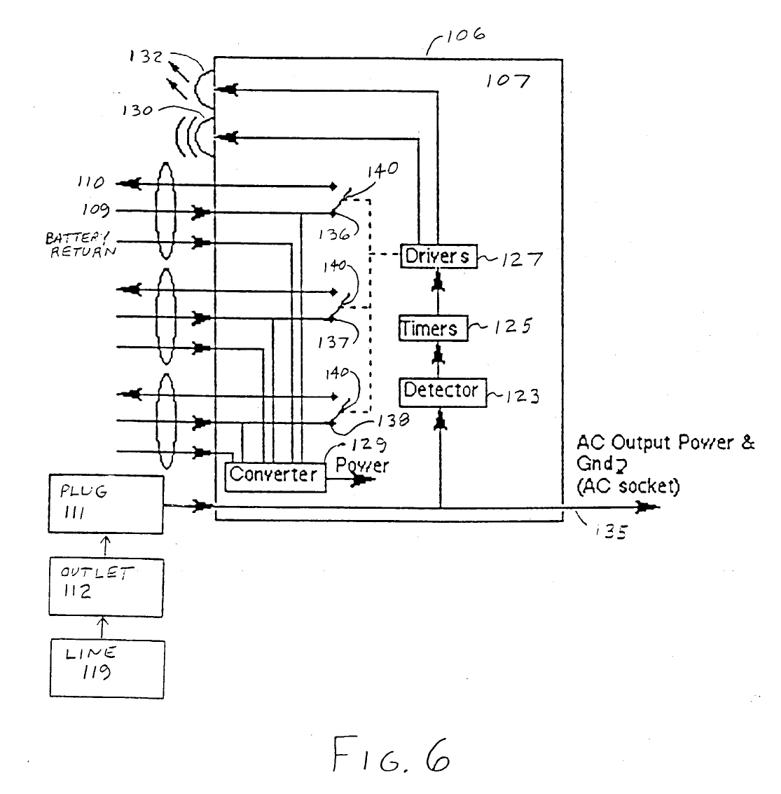

FIG. 6 is a block diagram emphasizing interrupter module 107 in more detail. Module 107 is a small unit including a voltage detector 123 for detecting a power outage of AC power source 118, and timers 125 including an outage timer for measuring the duration of the outage and a recovery timer for measuring a duration of power restoration after an outage. Drivers 127 are responsive to timers 125. Drivers 127 command relay 136 to open or close via relay control inputs 140, thereby selectively connecting node 109 to node 110.

Converter 129 converts the −48 volt power signal from batteries 104 to a voltage level usable by detector 123, timers 124, and drivers 127.

Relays 137 and 138 are provided in case cabinet 102 contains multiple battery systems and multiple shelves 30. In other words, interrupter 107 can interrupt power to multiple shelves 30, each fed from a separate cabinet power bus, for compatibility with distributed cabinet power practice.

Outlet 135, represented in FIG. 6, is a pass-thru grounded AC power outlet, to functionally replace the outlet occupied by plug 111 of module 107. Outlet 135 has the same structure as outlet 112. When plug 111 is engaged with one of the sockets of outlet 112, both sockets of outlet 135 are coupled to power line 119.

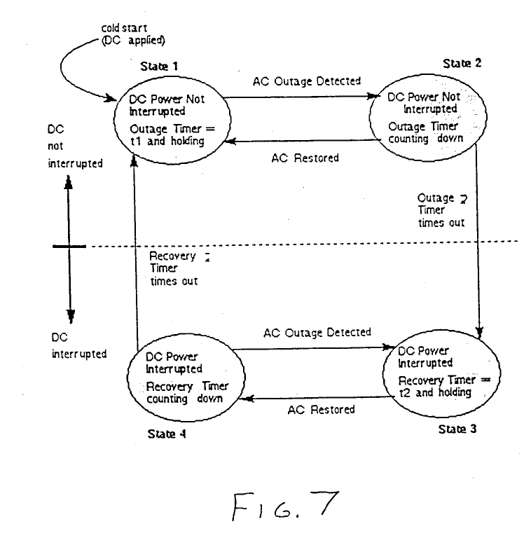

FIG. 7 is a state diagram describing the position of relay contacts 136, 137, and 138. Interrupter module 107 interrupts DC power input to access circuitry 25 in response to a local AC power outage persisting for more than a specified length of time, t1. When detector 123 detects an AC outage, timers 125 start an outage timing process. If AC power is restored before the time period t1 has elapsed, timers 125 reset the timing process, and any subsequent outage starts the timer process again from 0. Once the outage has persisted for the required time t1, drivers 127 command relays 136, 137, and 138 to open, thereby interrupting battery power to access circuitry 25. The time t1 may be several minutes, for example.

When detector 123 detects that AC power has been restored, timers 125 start a restoration timing process. When AC power has been restored without further interruption for a specified length of time t2 drivers 127 command relays 136, 137, and 138 to close. thereby restoring power to access circuitry 25.

Module 107 includes a light emitting diode (LED) 132 for visual status indication. Referring to FIG. 7, in state 1 (AC present, DC not interrupted) drivers 127 cause LED 132 to be continuous green. In state 2 (AC outage, DC not yet interrupted ) drivers 127 cause LED 132 to be flashing green. In state 3 (AC outage, DC interrupted) drivers 127 cause LED 132 to be continuous red. In state 4 (AC restored, but DC still interrupted) drivers 127 cause LED 132 to be flashing red.

Audible AC-outage indicator 130 may be a buzzer such as piezo transducer, for example. Drivers 127 activate indicator 130 during states 2 and 3 (AC outage). This feature alerts local craft in case they inadvertently unplug module 107, while looking for an AC-outlet for tools or test equipment, for example.

Timers 125 and drivers 127 cutoff indicator 130 after time period, t3, and clear this cutoff condition upon transition to state 1.

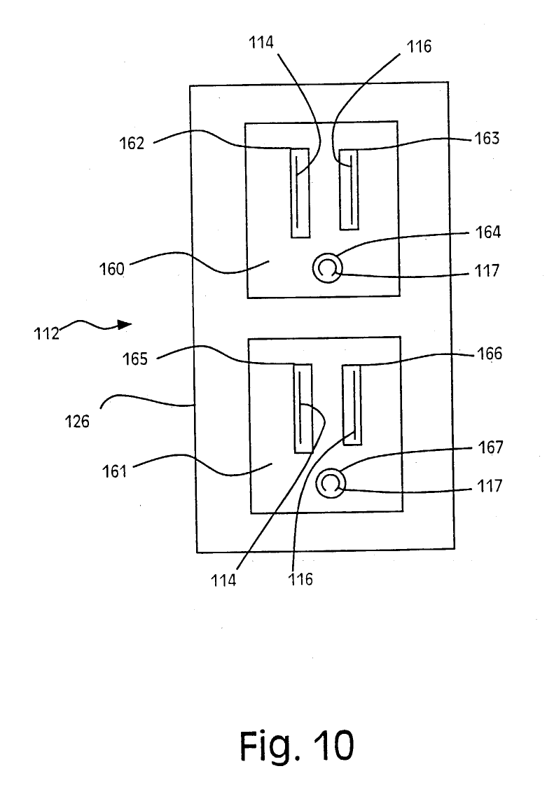

FIG. 10 shows outlet 112 in more detail. Outlet 112 includes an upper socket body 160 composed of an electrically insulating material, and lower socket body 161 composed of an electrically insulating material. Socket body 160 defines a left aperture 162, a right aperture 163, and a round aperture 164. Left contact 114 is inside of left aperture 162, right contact 116 is inside right aperture 163, and ground contact 117 is inside round aperture 164.

Socket body 165 is composed of an insulating material. Socket body 165 defines left aperture 165, right aperture 166, and round aperture 167. Left contact 114 is inside left aperture 165, right contact 116 is inside right aperture 166, and ground contact 117 is inside round aperture 167.

In summary, node 109 is downstream from power line 119. Outlet 112 includes housing 126 with socket body 160. Body 160 defines apertures 162, 163, and 164 having a certain spacing relative to each other. Outlet 112 includes electrical contact 114 in alignment with aperture 162, and contact 116 in alignment with aperture 163. Contacts 114 and 116 are electrically coupled to power line 119. Access circuitry 25 is essentially a load for dissipating power from node 109. A power distribution path from the node 109 to access circuitry 25 includes relay 136 having a control input 140 responsive to voltage detector 123 and timers 125, via drivers 127. This power distribution path excludes electrical outlet 112. Detector 112 is a type of sensor that monitors a signal from outlet 112, via plug 111, to generate a control signal for control input 140 of relay 136.

Contacts 113, 115, and 120 extend from insulating body 105 of plug 111. Contacts 113, 115, and 120 have a spacing corresponding the spacing of aperatures 162, 163, and 164.

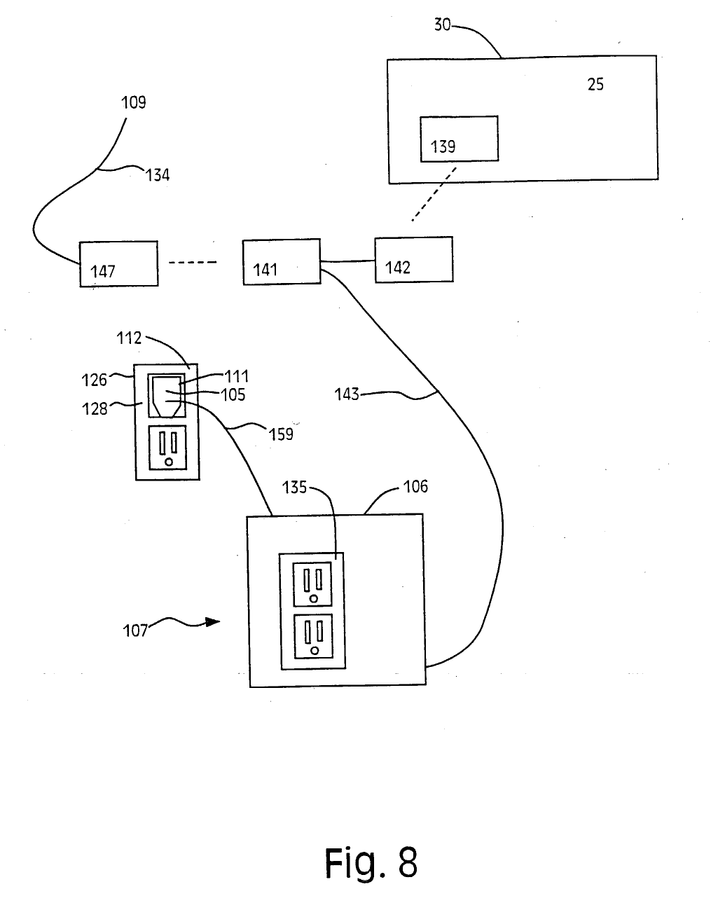

FIG. 8 is a diagram emphasizing some cabling in the preferred system. Module 107 includes male connector 141 and female connector 142 of interrupter cable 143. Connector 141 connects directly to connector 147, to connect node 109 with interrupter 107. Connector 142 connects with connector 139 to connect node 110 to access circuitry 25.

FIG. 9 shows the cabling arrangement of FIG. 8 in more detail. Male connector 141 includes a plastic, insulating housing 152 enclosing and supporting internal wires 146 and 151. Internal wire 146 is for transferring DC power from cable 134, via connector 147; to interrupter 107, via wire 149 in cable 143. Wires 146 and 149 are part of node 109.

Internal wire 151 is for transferring DC power from interrupter 107, via wire 155 in cable 143; to access circuitry 25, via inter-connector wire 157 and female connector 14. Wires 153, 155, and 157 are part of node 110.

“Y” splitters allow daisy-chaining of multiple shelves 30 off a single set of interrupter 107 terminals.

The power plug may a “pig-tail” type, as shown in FIG. 8, or may be mounted directly on the housing 106 of interrupter module 107. DC power connections are via via screw terminals, covered for safety. To minimize cable clutter, multiple sets of terminals may be provided on housing 106 of module 107, rather than by “Y” splitters.

In any event, a “Y” splitter physical design is presently preferred at the shelf 30 end of the cable between each shelf 30 and module 107 to electrically insert module 107 in the access circuitry 25 power path, thereby allowing easy addition of module 107 to existing installations, and avoiding substantial change in basic installation procedures or cabling.

Of course, certain numerical quantities will be specified depending on the requirements of the system. These quantities include battery voltage range, the outage and recovery time periods: t1 and t2, maximum power dissipated, maximum current controlled (based on maximum access circuitry 25 load).

It is preferred that the failure-to-trigger rate be such that interrupter 107 fails to interrupt DC power during less than 1% of all actual AC outages.

It is preferred that the false-triggering rate be such that interrupter 107 interrupts DC power inappropriately (i.e. when there is no AC outage) at a rate that decreases the total cell relay service reliability of the access circuitry 25 traffic by less than about 10%. Based on 22.7 min/yr down time for total cell relay service in cabinet applications, the false-triggering rate objective, above, translates to a FIT (failures in ten thousand hours) rate of about 1400 FITS (downtime of about 0.75 min/yr) for interrupter 107 (based on support of 3 shelves 30).

Module 107 maintains any isolation required between AC & DC inputs including grounds.

It is preferred that module 107 not falsely trip a ground fault interrupter, if cabinet 102 so equipped, upon installation, removal, or during operation.

The most economical embodiments may require some custom molding for housing 106 of module 107, and the cable connector (“Y”) preferably matches that on the load.

As a general design consideration, it is presently preferred that any malfunction of interrupter 107 tends to leave the access circuitry 25 powered.

Relays 136, 137, and 138 may be mechanical or may be solid state with no moving parts.

A set of the LTs share upstream bus 38 using a priority-based, cell grant multiplexing scheme, such as described in U.S. patent application Ser. No. 09/084,750 by PHILIPPE GUILLAUME DOBBELAERE and PASCAL LEFEBVRE, filed May 26, 1998 for a method of prioritized data transmission and data transmission arrangement. The contents of U.S. application Ser. No. 09/084,750 are herein incorporated by reference.

A priority-based, cell grant multiplexing scheme, is also described in U.S. patent application Ser. No. 09/022,177 by PHILIPPE GUILLAUME DOBBELAERE and GEERT ARTHUR EDITH VAN WONTERGHEM, filed Feb. 11, 1998 for a priority-based access control method and arrangement. The contents of U.S. application Ser. No. 09/022,177 are herein incorporated by reference.

The priority-based, cell grant multiplexing scheme, cited in the previous paragraph, is also described in European Patent Application No. 97400303.0 by PHILIPPE GUILLAUME DOBBELAERE and GEERT ARTHUR EDITH VAN WONTERGHEM, filed Feb. 11, 1997 for a Priority-based access control method and arrangement. The contents of European Patent Application No. 97400303.0 are herein incorporated by reference.

Systems and methods of detecting silent failures in redundant circuitry are disclosed U.S. patent application Ser. No. 09/450,714 by RICHARD M. CZERWIEC, JAN DE GROOTE, RICHARD R. RZONCA, MARLIN V. SIMMERING, and GEERT VAN WONTERGHEM filed Nov. 30, 1999 for COMMUNICATION SYSTEM HAVING ENHANCED RELIABILITY, the contents of which is herein incorporated by reference.

Interrupter 107 of the embodiment described above is an external implementation, in the sense that interrupter 107 is a separate module installed outside the access circuitry 25. One advantage of this external implementation is that it facilitates control of power to multiple shelves 30.

The connection arrangement of the preferred system may be contrasted with the conventional scheme in which a female connector of cable 134 would connect directly to male connector 139 of access circuitry 25.

Module 107 including the connector arrangement described above provides a general-purpose method of retrofitting a system to add a power interrupter function with minimal modification to existing hardware. The connector arrangement allows quick insertion of the module 107 into the electrical path to a load, with only a brief downtime.

According to an alternative embodiment, the interrupter is integrated into access circuitry 25 itself.

Additional advantages and modifications will readily occur to those skilled in the art. The invention in its broader aspects is therefore not limited to the specific details, representative apparatus, and illustrative examples shown and described. Accordingly, departures may be made from such details without departing from the spirit or the scope of Applicants' general inventive concept. The invention is defined in the following claims.

What is claimed is:

1. In a first system including a building with a subscriber, and a structure located away from the building, a communication system comprising:
a first circuit for sending a first signal from the structure to the building;
a second circuit for sending a second signal from the structure to the building, while the first circuit sends the first signal;
a generator that generates a DC power signal in response to an AC power signal;
a battery coupled to the generator and to the first circuit;
a detector that detects a condition of the AC power signal, to generate a detector signal;
a switch between the battery and the second circuit, the switch being responsive to the detector signal, to decouple the battery from the second circuit while maintaining a coupling of the battery to the first circuit.

2. The communication system of claim 1 wherein the first system further includes a current path between the building and the structure, and the first circuit is configured to send the first signal onto the current path, and the second circuit is configured to send the second signal onto the current path.

3. The communication system of claim 1 wherein the first circuit includes a telephone circuit.

4. The communication system of claim 1 wherein the second circuit includes an encoder for receiving a digital signal and encoding to generate the second signal.

5. The communication system of claim 1 wherein the first circuit includes a telephone circuit and the second circuit includes an encoder for receiving a digital signal and encoding to generate the second signal.

6. The communication system of claim 1 wherein the generator is coupled in parallel with the battery.

7. The communication system of claim 1 wherein the detector includes a timer for generating the detector signal to cause the switch to open a predetermined time after a disruption of the AC power signal.

8. The communication system of claim 1 wherein the detector includes a timer for generating the detector signal to cause the switch to close a predetermined time after a restoration of the AC power signal.

9. The communication system of claim 1 wherein the first system further includes an AC power outlet defining first and second apertures, the communication system further including a plug removably connected to the AC power outlet, wherein the detector includes a signal path for receiving a signal through the plug.

10. The communication system of claim 1 wherein the structure defines an interior, and exterior, and a wall, and the first system further includes an AC power outlet defining first and second apertures on the wall, the communication system further includes a plug removably connected to the AC power outlet, wherein the detector receives a signal through the plug, and the first circuit is in the interior.

11. The communication system of claim 9 wherein the encoder is in the interior.

12. A communication system for a first system with a building with a subscriber, and a structure located away from the building, and a battery, the communication system comprising:
first sending means for sending a first signal from the structure to the building;
second sending means for sending a second signal from the structure to the building, concurrently with the previous means;
a conducting path for making a coupling between the battery and the first sending means;
means for generating a DC power signal in response to an AC power signal and sending the DC power signal to the battery;
means for detecting a condition of the AC power signal, to generate a third signal; and
means for selectively decoupling the battery from the second sending means, depending on the third signal, while maintaining the coupling of the battery to the first sending means.

13. The communication system of claim 12 wherein the first system further includes a current path between the building and the structure, and the first sending means includes: means for sending the first signal onto the current path, and the second sending means includes;
means for sending the second signal onto the current path.

14. The communication system of claim 12 wherein the first sending means includes a sender for sending a voice signal.

15. The communication system of claim 12 wherein the second sending means includes a receiver for receiving a digital signal and an encoder to generate the second signal.

16. The communication system of claim 12 wherein the first sending means for sending the first signal includes a telephone voice circuit, and the second sending means includes receiving a digital signal and an encoder encoding to generate the second signal.

17. The communication system of claim 12 further the means for detecting includes a timer.

18. The communication system of claim 12 further the first system further includes an AC power outlet defining first and second apertures, and the means for detecting includes a receiver that receives a signal through the AC power outlet.

19. The communication system of claim 12 wherein the structure defines an interior, and exterior, and a wall, and the first system further includes an AC power outlet defining first and second apertures on the wall, the communication system further includes a plug removably connected to the AC power outlet, and the means for detecting receives a signal through the plug.

20. A method for a system including a building with a subscriber, and a structure located away from the building, and a structure enclosing first and second circuits, a battery coupled to the first circuit, the method comprising:
sending a first signal from the first circuit to the building;
concurrently with the previous step, sending a second signal from the second circuit to the building;
generating a DC power signal in response to an AC power signal and sending the DC power signal to the battery;
detecting a condition of the AC power signal, to generate a third signal; and
selectively decoupling the battery from the second circuit, depending on the third signal, while maintaining the coupling of the battery to the first circuit.

21. The method of claim 20 wherein the system further includes a current path between the building and the structure, and sending the first signal includes sending the first signal onto the current path, and sending the second signal includes sending the second signal onto the current path.

22. The method of claim 20 wherein sending the first signal includes sending a voice signal.

23. The method of claim 20 wherein sending the second signal includes receiving a digital signal and encoding to generate the second signal.

24. The method of claim 20 wherein sending the first signal includes sending a voice signal, and sending the second signal includes receiving a digital signal and encoding to generate the second signal.

25. The method of claim 20 further includes generating the third signal to cause the switch to open a predetermined time after a disruption of the AC power signal.

26. The method of claim 20 further including generating the third signal to cause the switch to close a predetermined time after a restoration of the AC power signal.

27. The method of claim 20 further wherein the system further includes an AC power outlet defining first and second apertures, and a plug removably connected to the AC power outlet, and detecting includes receiving a signal through the plug.

28. The method of claim 20 wherein the structure defines an interior, and exterior, and a wall, and the system further includes an AC power outlet defining first and second apertures on the wall, a plug removably connected to the AC power outlet, and detecting includes receiving a signal through the plug

29. The method of claim 28 wherein encoding is performed in the interior.

30. A system for operating with a power line, a power node downstream from the power line, an electrical outlet with a housing having an insulating face plate, the face plate having openings with a spacing, and electrical contacts in alignment with each of the openings in the face plate, the electrical contacts being coupled to the power line, the system comprising:
a load for dissipating power from the power node;
a power distribution path from the power node to the load, the power distribution path including a switch having a control input, the power distribution path excluding the electrical outlet; and
a sensor for monitoring a first signal from the electrical outlet, to send a control signal to the control input of the switch.

31. The system of claim 30 wherein the power distribution path includes a generator that receives an AC signal from the power line and sends a DC signal toward the power node.

32. The system of claim 30 further including a plug with an insulating body, and plug contacts extending from the insulating body, the plug contacts having a spacing corresponding the spacing of the openings in the face plate, wherein the sensor monitors the first signal through one of the plug contacts.

33. The system of claim 30 wherein the sensor is powered through a path excluding the electrical outlet.

34. The system of claim 30 wherein the sensor is powered from a path connected to the power distribution path from the power line to the load.

35. The system of claim 30 further including a housing, wherein the sensor and switch are in the housing, and the load is outside the housing.

36. The system of claim 35 further including a plug with an insulating body, and plug contacts extending from the insulating body, the plug contacts having a spacing corresponding the spacing of the openings in the face plate, wherein the sensor monitors the first signal through one of the plug contacts.

37. The system of claim 35 further including a cable extending from the housing, a plug connected to the cable, wherein the plug includes an insulating body, and plug contacts extending from the insulating body, the plug contacts having a spacing corresponding the spacing of the openings in the face plate, wherein the sensor monitors the first signal through one of the plug contacts.

38. A method for system including a power line, a load, and an electrical outlet with a housing having an insulating face plate, the face plate having openings with a spacing, an electrical contacts in alignment with each of the openings in the face plate, the electrical contacts being coupled to the power line, the method comprising:
receiving power from the power line through a path including a switch having a control input, and excluding the electrical outlet and dissipating the received power in the load;
monitoring a first signal from the electrical outlet, to send a control signal to the control input of the switch.

39. The method of claim 38 further including receiving an AC signal in the power distribution path and sending a DC signal toward the power node in the power distribution path.

40. The method of claim 38 wherein the system further includes a plug with an insulating body, and plug contacts extending from the insulating body, the plug contacts having a spacing corresponding the spacing of the openings in the face plate, and monitoring includes monitoring the first signal through one of the plug contacts.

41. The method of claim 38 powering performance of the monitoring step through a path excluding the electrical outlet.
